(19) United States
(12) Patent Application Publication
(10) Pub. No.: US 2023/0018812 A1
(43) Pub. Date: Jan. 19, 2023

(54) IMAGE FORMATION WITH ULTRASONIC LIQUID REMOVAL

(71) Applicant: Hewlett-Packard Development Company, L.P., Spring, TX (US)

(72) Inventor: Viktor Shkolnikov, Palo Alto, CA (US)

(73) Assignee: Hewlett-Packard Development Company, L.P., Spring, TX (US)

(21) Appl. No.: 17/783,406

(22) PCT Filed: Jan. 14, 2020
(86) PCT No.: PCT/US2020/013518

§ 371 Date: Jun. 8, 2022

(51) Int. Cl. B41J 2/165; B41J 2/005

(52) U.S. Cl. CPC B41J 2/16517; B41J 2/0057; B41J 2002/16567

(57) ABSTRACT

An image formation device includes a support, a fluid ejection device, and a first porous element. The support is to support movement of a substrate along a travel path, while the fluid ejection device is located along the travel path to deposit droplets of colorants within a liquid carrier onto the substrate to at least partially form an image on the substrate. A first porous element is located downstream from the fluid ejection device to be in contact against the substrate to remove, via capillary flow, at least a portion of the liquid carrier from the substrate. An ultrasonic element is in contact against the first porous element, at a location separated from a location at which the first porous element engages the substrate, to drive the removed liquid carrier out of the first porous element.

### BACKGROUND

Modern printing techniques involve a wide variety of media, whether rigid or flexible, and for a wide range of purposes. In some printing techniques, a liquid carrier may be used as part of depositing a marking agent onto a substrate when forming an image.

### BRIEF DESCRIPTION OF THE DRAWINGS

FIG. 1 is a diagram including side views schematically representing at least some aspects of an example image formation device.

FIG. 2 is a diagram including a side view schematically representing an example first porous element in the form of an outer portion of a rotatable drum.

FIG. 3 is a diagram including a side view schematically representing an example first porous element in the form of a belt about a first roller.

FIG. 4A is a diagram including a side view schematically representing an example liquid removal via a first porous element and an ultrasonic element.

FIG. 4B is a diagram including a side view schematically representing an example first porous element including a plurality of channels.

FIGS. 4C-4D are each a diagram including a side view schematically representing a layered structure of an example first porous element.

FIG. 5 is a diagram including a side view schematically representing an example image formation device including a rotatable drum-type substrate.

FIG. 6 is a diagram including a side view schematically representing an example image formation device including belt-type substrate.

FIG. 7A is a diagram including a side view schematically representing an example image formation device including a liquid removal arrangement, which includes an ultrasonic element and a first porous element in a drum-type arrangement.

FIGS. 7B-7E are each a diagram including a side view of example liquid removal arrangements with an ultrasonic element in different positions relative to a drum-type first porous element.

FIG. 8A is a diagram including a side view schematically representing an example image formation device including a liquid removal arrangement, which includes an ultrasonic element and a first porous element in a belt-type arrangement.

FIG. 8B is a diagram including a side view of an example liquid removal arrangement with a drum-type ultrasonic element and a belt-type first porous element.

FIG. 9A is a diagram including a side view schematically representing an example image formation device including a substrate as an image formation medium, and a liquid removal arrangement, which includes an ultrasonic element and a first porous element in a belt-type arrangement.

FIG. 9B is a diagram including a side view schematically representing an example image formation device including a substrate as an image formation medium, and a liquid removal arrangement, which includes an ultrasonic element and a first porous element in a drum-type arrangement.

FIG. 10 is a diagram including side views schematically representing at least some aspects of an example image formation device, including a first porous element for liquid removal from a substrate.

FIG. 11 is a diagram including a side view schematically representing an example image formation device including a rotatable drum-type substrate and a charge emitter for electrostatic fixation of colorants.

FIG. 12A is a block diagram schematically representing an example image formation engine.

FIG. 12B is a block diagram schematically representing an example control portion.

FIG. 12C is a block diagram schematically representing an example user interface.

FIG. 13 is a flow diagram schematically representing an example method of image formation.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense. It is to be understood that features of the various examples described herein may be combined, in part or whole, with each other, unless specifically noted otherwise.

In some examples, an image formation device comprises a fluid ejection device and a first porous element. The fluid ejection device is located along a travel path of a substrate to deposit droplets of colorants within a liquid carrier onto the substrate to at least partially form an image on the substrate.

The first porous element is located downstream along the travel path from the fluid ejection device to be in contact against the substrate to remove, via capillary-induced flow through the first porous element, at least a portion of the liquid carrier from the substrate. In some such examples, the support is to support movement of a substrate along a travel path. In some such examples, the area of contact between the first porous element and the substrate may sometimes be referred to as a first liquid removal zone or first contact zone.

In some examples, the colorants make comprise ink particles, pigments, dyes, and/or other marking agents which may be deposited within, and/or via, a liquid carrier. In some such examples, at least some types of the colorants, such as but not limited to the dye molecules, may covalently or non-covalently attach to the substrate with sufficient strength to avoid being removed (with the liquid carrier) from the substrate via the capillary action of the first porous element media.

In some examples, an ultrasonic element may engage the first porous element at a location remote (e.g. separated from) the first contact zone at which the first porous element engages the substrate. Via ultrasonic energy applied via the ultrasonic element, liquid is driven from the first porous element to dry the first porous element for further, later engagement with the substrate. In some such examples, the area of contact between the ultrasonic element and the first porous element may sometimes be referred to as a second liquid removal zone or second contact zone. As noted above, the second liquid removal zone is located separate from (e.g. remote) the first liquid removal zone, such as the second liquid removal zone being downstream from the area of contact between the first porous element and the substrate.

In some examples, the liquid carrier may comprise an aqueous-based liquid carrier.

In some such examples, large volumes of the liquid carrier may be rapidly removed from the substrate (after image formation via colorants) without costly heating or evaporation mechanisms as a primary means of removing such liquid. The costly expense may be viewed as being costly from a monetary perspective and/or costly from an energy usage perspective. Moreover, in some examples the removal of liquid via engagement of the first porous element relative to the substrate may be implemented without mechanical elements (at the site of engagement) such as blades, squeegee rollers, while still achieving desirable speed and/or volume of liquid removal of aqueous-based liquids from the substrate.

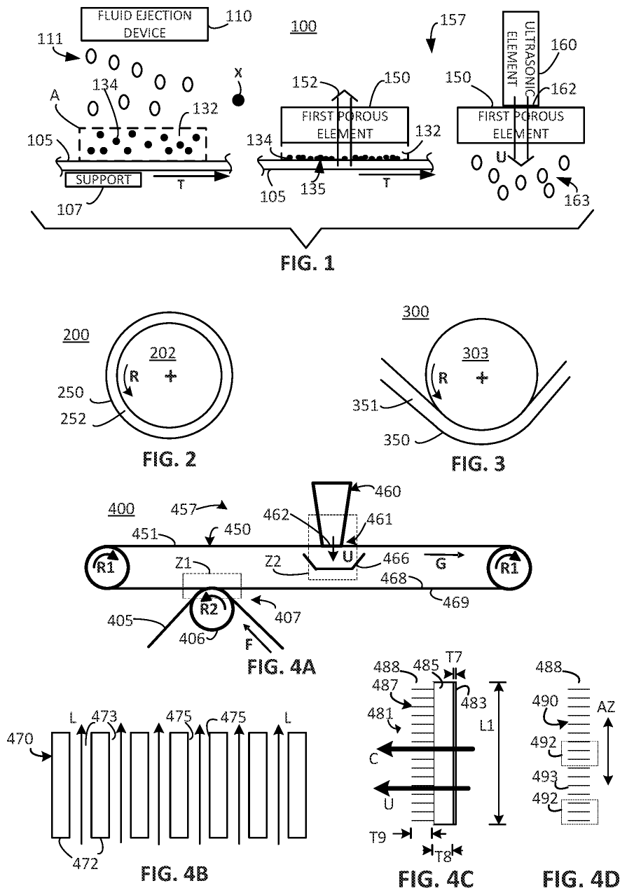

These examples, and additional examples, are further described below in association with at least FIGS. 1-13.

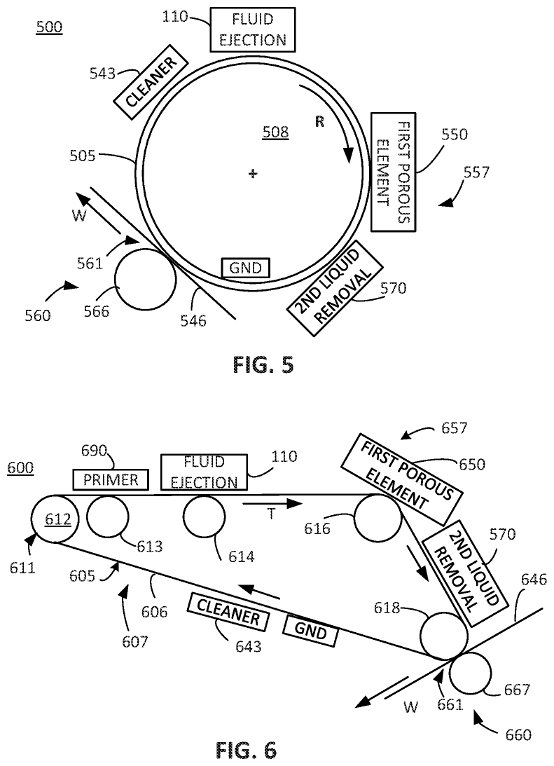

FIG. 1 is a diagram including side views schematically representing at least some aspects of an example image formation device 100. As shown in FIG. 1, a support 107 supports a substrate 105 for movement along a travel path T. The support 107 may take various forms such as, but not limited to, a rotatable drum or a plurality of rollers, as later described in association with at least FIG. 5 and FIG. 6, respectively.

As further shown in FIG. 1, in some examples the image formation device 100 comprises a fluid ejection device 110 and a first porous element 150. The fluid ejection device 110 is located along the travel path T to deposit droplets 111 of colorants 134 within a liquid carrier 132 onto the substrate 105 to at least partially form an image on the substrate 105, as represented within dashed box A.

In some examples, the first porous element 150 is located downstream along the travel path T from the fluid ejection device 110. As shown in FIG. 1, among other features the first porous element 150 is in contact against the substrate 105 to remove, via capillary-induced flow through the first porous element 150, at least a portion of the liquid carrier 132 from the substrate 105.

In some such examples, the contact between the first porous element 150 and the substrate 105 may comprise moving contact, such as rolling contact between the belt 152 and the substrate 105. However, in some examples, the moving contact may comprise sliding contact. In some examples, such as when the liquid carrier comprises an aqueous liquid carrier, the first porous element may be more hydrophilic (e.g. have a greater contact angle) than the substrate 105.

As further shown in FIG. 1, the example image formation device 100 comprises an ultrasonic element 160 downstream along the travel path T from the location at which the first porous element 150 is in contact against the substrate 105 (e.g. a first contact zone). The ultrasonic element 160 is in contact against the first porous element 150 to define a second contact zone, and when energized, produces ultrasonic waves to drive liquid out of the first porous element 150, as represented by arrow U, such as in the form of droplets 163. In some examples, the ultrasonic waves produce directional cavitation in the liquid within the first porous element to cause the liquid to exit the first porous element 150.

In some examples, the ultrasonic element 160 may comprise an ultrasonic horn with a first end portion 162 of the ultrasonic element 160 comprising a size and/or shape adapted to form a small nip relative to the first porous element 150. Via this arrangement, upon relative movement between the first porous element 150 and the ultrasonic element 160, the ultrasonic energy emitted by the ultrasonic element 160 will be concentrated at end portion 162 of ultrasonic element 160 at an appropriate intensity to cause the desired cavitation to drive liquid out of the first porous element 150, such as schematically represented in FIG. 1. Accordingly, via such arrangements, the ultrasonic element 160 produces ultrasonic waves, which may act to pump the liquid carrier and/or any other fluid out of the first porous element 150 using acoustic waves, such as ultrasonic frequencies, directed in the direction of desired fluid motion.

In some examples, the ultrasonic element 160 may comprise various types of materials and/or structures, such as but not limited to piezoelectric transducers, electromagnetic acoustic transducers, and the like. In some such examples, the piezoelectric transducers may comprise piezocrystals, piezo ceramics, piezopolymers, piezocomposites, and the like. Upon application of an electrical signal to the piezoelectric transducer, pressure in the form of vibrations are generated, which in turn produces the ultrasonic waves of interest. In some examples, the electromagnetic acoustic transducer may be utilized in association with electrically conductive materials. In some such examples, at least a portion of the structure and/or materials of the first porous element 150 are electrically conductive to enable the first porous element 150 to act as coupling medium to transmit the electromagnetically-generated ultrasonic waves into the liquid to be driven out of the first porous element 150.

In some examples, the ultrasonic element 160 may produce ultrasonic waves having a frequency on the order of hundreds of kiloHertz. In some examples the frequency may be on the order of 100 kiloHertz.

In some examples, the first porous element 150 and/or the ultrasonic element 160 may be considered to be part of a, and/or sometimes referred to as, a liquid removal arrangement 157.

In some examples, the fluid ejection device 110 comprises a drop-on-demand fluid ejection device, which may deposit droplets which include the colorants within the liquid carrier. In some examples, the drop-on-demand fluid ejection device comprises an inkjet printhead to deposit the colorants. In some examples, the inkjet printhead comprises a piezoelectric inkjet printhead. In some examples, the fluid ejection device 110 may comprise other types of inkjet printheads. In some examples, the inkjet may comprise a thermal inkjet printhead. In some examples, the droplets may sometimes be referred to as being jetted onto the media. With this in mind, at least some of the aspects and/or implementations of image formation according to at least some examples of the present disclosure may sometimes be referred to as “jet-on-media”, “jet-on-substrate”, “jet-on-blanket”, “offjet printing”, and the like.

It will be understood that in some examples, the fluid ejection device 110 may comprise a permanent component of image formation device 100, which is sold, shipped, and/or supplied, etc. as part of image formation device 100. It will be understood that such “permanent” components may be removed for repair, upgrade, etc. as appropriate. However, in some examples, fluid ejection device 110 may be removably received, such as in instances when fluid ejection device 110 may comprise a consumable, be separately sold, etc.

In some examples, the liquid carrier 132 may comprise an aqueous liquid carrier.

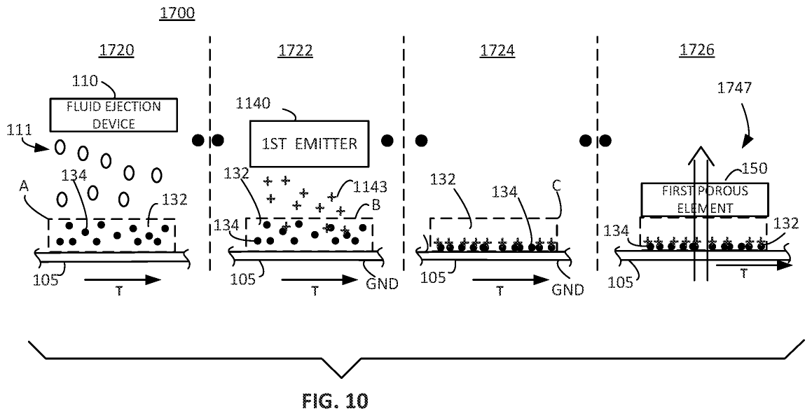

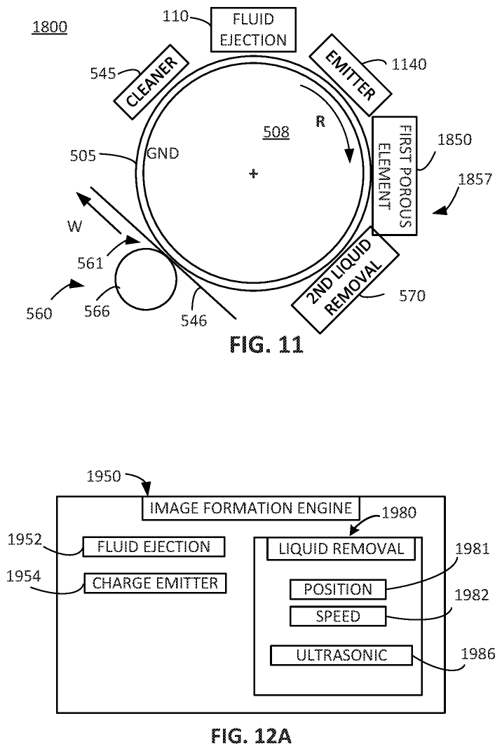

However, in some examples, the liquid carrier 132 may comprise a non-aqueous liquid carrier, such as in the example image formation devices described in association with at least FIGS. 10-11. In some such examples, when non-aqueous dielectric liquid carriers are used, and when electrostatic fixation (i.e. pinning) of colorants 134 is implemented as shown in FIGS. 10 and 11, an electrically conductive element separate from the substrate 105 is provided to contact the substrate 105 in order to implement grounding of the substrate 105.

In some examples, substrate 105 comprises a metallized layer or foil.

However, in some examples, the substrate 105 is not metallized and comprises no conductive layer.

In some examples, the substrate 105 comprises a non-absorbing material, non-absorbing coating, and/or non-absorbing properties. Accordingly, in some examples the substrate 105 is made of a material which hinders or prevents absorption of liquids, such as a liquid carrier 132 and/or other liquids in the droplets received on the medium. In one aspect, in some such examples the non-absorbing medium does not permit the liquids to penetrate, or does not permit significant penetration of the liquids, into the surface of the non-absorbing medium.

The non-absorbing example implementations of the substrate 105 stands in sharp contrast to some forms of media, such as paper, which may absorb liquid. The non-absorbing attributes of the substrate 105 may facilitate drying of the colorants on the media at least because later removal of liquid from the media will not involve the time and expense of attempting to pull liquid out of the media (as occurs with absorbing media) and/or the time, space, and expense of providing heated air for extended periods of time to dry liquid in an absorptive media.

Via the above-described example arrangements in which a first porous element is used to remove a liquid carrier from a substrate, the example device and/or associated methods can print images on a non-absorbing medium (or some other medium) with minimal bleeding, dot smearing, etc. while permitting high quality color on color printing. Moreover, via these examples employing ultrasonic liquid removal, image formation on a non-absorbing medium (or some other medium) can be performed with less time, less space, and less energy at least due to a significant reduction in drying time and capacity. These example arrangements stand in sharp contrast to other printing techniques (those lacking such ultrasonic flow-based liquid removal), such as high coverage, aqueous-based inkjet printing utilizing roller-to-roller nip based liquid removal (or similar mechanical elements) which may not adequately remove the liquid unless higher cost, lengthy drying is applied.

In some such examples, the non-absorptive substrate 105 may comprise other attributes, such as acting as a protective layer for items packaged within the media. Such items may comprise food or other sensitive items for which protection from moisture, light, air, etc. may be desired.

With this in mind, in some examples the substrate 105 may comprise a plastic media. In some examples, the substrate 105 may comprise polyethylene (PET) material, which may comprise a thickness on the order of about 10 microns. In some examples, the substrate 105 may comprise a biaxially oriented polypropylene (BOPP) material. In some examples, the substrate 105 may comprise a biaxially oriented polyethylene terephthalate (BOPET) polyester film, which may be sold under trade name Mylar in some instances. In some examples, the substrate 105 may comprise other types of materials which provide at least some of the features and attributes as described throughout the examples of the present disclosure. For examples, the substrate 105 or portions of substrate 105 may comprise a metallized foil or foil material, among other types of materials.

In some examples, substrate 105 comprises a flexible packaging material. In some such examples, the flexible packaging material may comprise a food packaging material, such as for forming a wrapper, bag, sheet, cover, etc. As previously mentioned for at least some examples, the flexible packaging materials may comprise a non-absorptive media.

In some examples, the image formation device may sometimes be referred to as a printer or printing device. In some examples in which a media is supplied in a roll-to-roll arrangement or similar arrangements, the image formation device may sometimes be referred to as a web press and/or the print medium can be referred to as a media web.

At least some examples of the present disclosure are directed to forming an image directly on a print medium, such as without an intermediate transfer member. Accordingly, in some instances, the image formation may sometimes be referred to as occurring directly on substrate 105, which may sometimes be referred to the print medium in such instances. However, this does not necessarily exclude some examples in which an additive layer may be placed on the print medium prior to receiving colorants (within a carrier fluid) onto the print medium. In some instances, the print medium also may sometimes be referred to as a non-transfer medium to indicate that the medium itself does not comprise a transfer member (e.g. transfer blanket, transfer drum) by which an ink image is to be later transferred to another print medium (e.g. paper or other material). In this regard, the print medium may sometimes also be referred to as a final medium or a media product. In some such instances, the medium may sometimes be referred to as product packaging medium.

In some examples, the substrate 105 may sometimes be referred to as a non-transfer substrate, i.e. a substrate which does not act as a transfer member (e.g. a member by which ink is initially received and later transferred to a final substrate bearing an image). Rather, in some such examples, the substrate 105 may comprise a final print medium such that the printing or image formation may sometimes be referred as being direct printing because no intermediate transfer member is utilized as part of the printing process.

In some examples, the substrate 105 comprises an intermediate transfer member, such as (but not limited to) the example image formation device 500 further described in association with at least FIGS. 5-6 and 11. In some instances, such an intermediate transfer member may be referred to as a blanket.

As shown in FIG. 1, in some examples, there are no features, elements, etc. (along the travel path T) located between the fluid ejection device 110 and the first porous element 150. However, as schematically represented by the black dot X, in some examples the image formation device 100 may comprise additional features, elements, etc. located along the travel path T between the fluid ejection device 110 and the first porous element 150. For instance, in some examples the image formation device 100 may comprise a charge emitter (e.g. located after the fluid ejection device 110) to emit electrostatic charges onto the deposited droplets 111 to cause electrostatic migration toward, and electrostatic fixation of, the colorants 134 relative to the substrate, as further described in association with at least FIGS. 10-11.

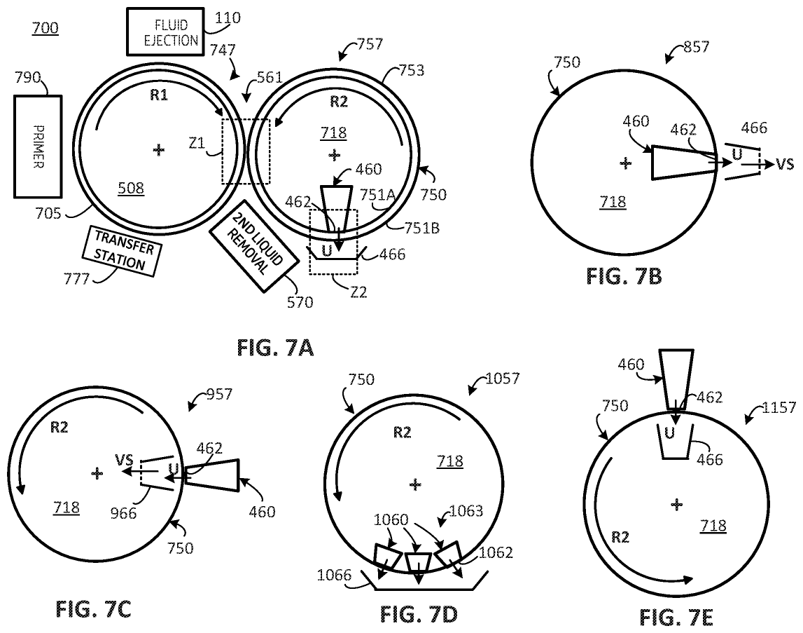

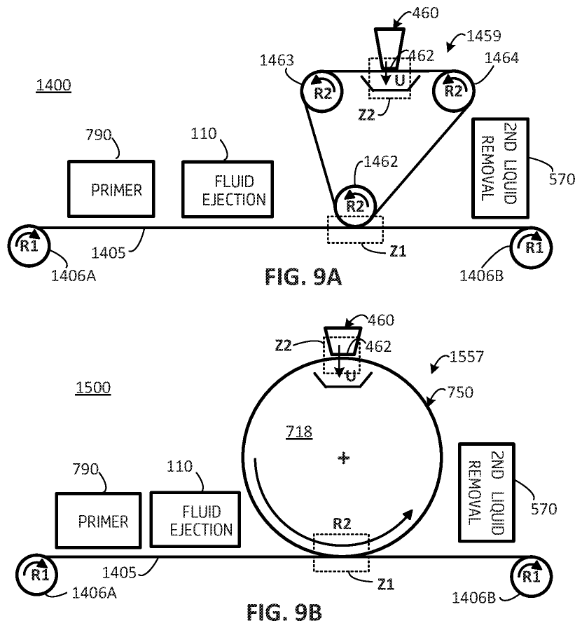

FIG. 2 is a diagram 200 including a side view schematically representing an example first porous element 250 in the form of an outer portion 252 of a rotatable drum 202. In some such examples, the first porous element 250 comprises at least some of substantially the same features and attributes as first porous element 150 in FIG. 1. Further details regarding such an example first porous element 250, arranged as an outer portion 252 of a rotatable drum 202, are further described in association with at least FIGS. 7A-7E, 9B.

FIG. 3 is a diagram 300 including a side view schematically representing an example first porous element 350 in the form of a belt 351 being supported by, and rotating about, a first roller 303. In some such examples, the first porous element 350 comprises at least some of substantially the same features and attributes as first porous element 150 in FIG. 1. Further details regarding such example first porous elements 350, arranged as a belt 351, are further described in association with at least FIGS. 4A, 8A-8B, and 9A.

FIG. 4A is a diagram 400 including a side view schematically representing an example liquid removal arrangement 457 for removing liquid from a substrate 405. In some examples, the liquid removal arrangement 457 comprises at least some of substantially the features and attributes of, and/or comprises an example implementation of, the liquid removal arrangement 157 of FIG. 1. As shown in FIG. 4A, the liquid removal arrangement 457 comprises a first porous element 450 in moving contact (e.g. rolling contact) against a substrate 405 to induce capillary flow of liquid 132 into the first porous element 450 to remove liquid from the substrate 405 while not disturbing the deposited colorants 134 on the substrate 405. In some examples, the region of contact of the first porous element 450 with substrate 405 may sometimes be referred to as a first contact zone (referenced via dashed box Z1) and this region of contact also may be understood to define a first nip 407 in which pressure is exerted over a small area of contact between the first porous element 450 and the substrate 405.

As further shown in FIG. 4A, the first porous element 450 forms part of the liquid removal arrangement 457 in which the first porous element 450 comprises a belt 451 supported by, and rotating in an endless loop, about a plurality of rollers, such as rollers 409A, 409B with at least one of these rollers comprising a drive roller. Each of the rollers 409A, 409B (supporting belt 1251) rotate in a first direction (clockwise in this example as represented by arrow Ra), while a roller 406 and substrate 405 rotate or move in a second direction (counterclockwise as represented by arrow R2).

In some such examples, the first porous element 450 (as belt 451) may sometimes be referred to as an endless belt because it forms a loop about a plurality of rollers in some examples, with the belt having no discrete end or beginning. In some examples, the belt 451 also may be referred to as rotating in an endless loop, i.e. a loop having no discrete end or beginning. It will be further understood that the scope of the terms “endless”, “loop” and the like in association with the terms “belt” may be applicable with respect to other examples of the present disclosure in an appropriate context.

Roller 406 is positioned to force substrate 405 into pressing contact against the first porous element 450 to define the nip 407 which also defines a first contact zone Z1 (e.g. first liquid removal zone) such that, via a capillary flow action induced by the first porous element 450, liquid is removed from the substrate 405 and into the first porous element 450.

Because the first porous element 450 in the form of a belt 451 rotates in a loop (as represented by directional arrow G), different portions of belt 451 will engage the substrate 405 as the belt 451 rotates. Similarly, at the same time that the belt 451 is rotating (directional arrow G) in a loop, the substrate 405 is moving as represented via directional arrow F and per rotation (e.g. R2) of roller 406. As shown in FIG. 4A, roller 406 rotates (arrow R2) in a direction complementary with the revolution of belt 451 in a loop. In some such examples, the belt 451 moves (rotates in the endless loop) at a speed which is substantially the same as the speed at which substrate 405 moves per roller 406. In one aspect, this arrangement may minimize or eliminate shear forces, which might otherwise be present if the belt 451 and substrate 405 were moving at substantially different speeds.

As further shown in FIG. 4A, the liquid removal arrangement 757 comprises an ultrasonic element 460 (FIG. 4A) with a first end portion 462 of the ultrasonic element 460 in slidable contact against an outer surface 469 of the first porous element 450 (e.g. as belt 451), which moves past the ultrasonic element 460. In some examples, the first end portion 462 and the ultrasonic element 460 generally comprises at least some of substantially the same features and attributes as the first end portion 162 and the ultrasonic element 160 generally, as previously described in association with at least FIG. 1. In some examples, the region of contact between the ultrasonic element 460 and first porous element 450 may sometimes be referred to as a second contact zone Z2 (e.g. second liquid removal zone) and defines a nip 461. In this arrangement, the ultrasonic element 460 emits ultrasonic waves to drive (e.g. pump) the liquid (earlier removed from the substrate 405 in zone Z1) out of the first porous element 450 and into the collection reservoir 466 (as represented via directional arrow U), which is positioned on an opposite side of the first porous element 450 from the ultrasonic element 460. Via this particular configuration in which the ultrasonic element 460 is aligned in a vertical orientation relative to, and above, the collection reservoir 466, gravity may act to guide the expelled liquid directly into the reservoir 466. The collected liquid may be recycled, reused, and/or discarded.

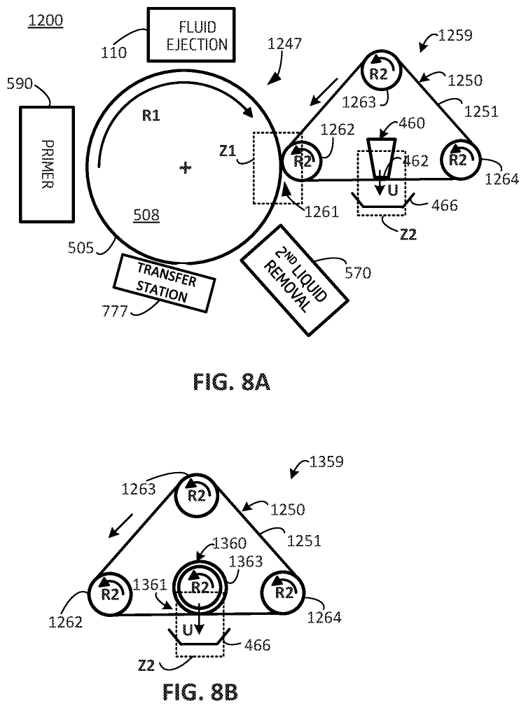

As further shown in FIG. 4A, in this example implementation the ultrasonic element 460 is positioned external to the first porous element 450 and the collection reservoir 466 positioned within an interior of the loop defined by the first porous element 450. However, in some examples, one of the different positioning or orientation configurations of the ultrasonic elements and reservoirs shown in FIGS. 7A-7E, 8A-8B may be implemented in the arrangement of FIG. 4A.

Accordingly, via the arrangement shown in FIG. 4A, in the first contact zone Z1, the first porous element 450 acts to remove excess liquid carrier (132 in FIG. 1) from the substrate 405 and at a later time in second contact zone Z2, the ultrasonic element 460 drives (e.g. pumps) the liquid out of the first porous element 450 (into collection reservoir 466) to prepare the first porous element 450 to receive more liquid in its next pass through the first contact zone Z1.

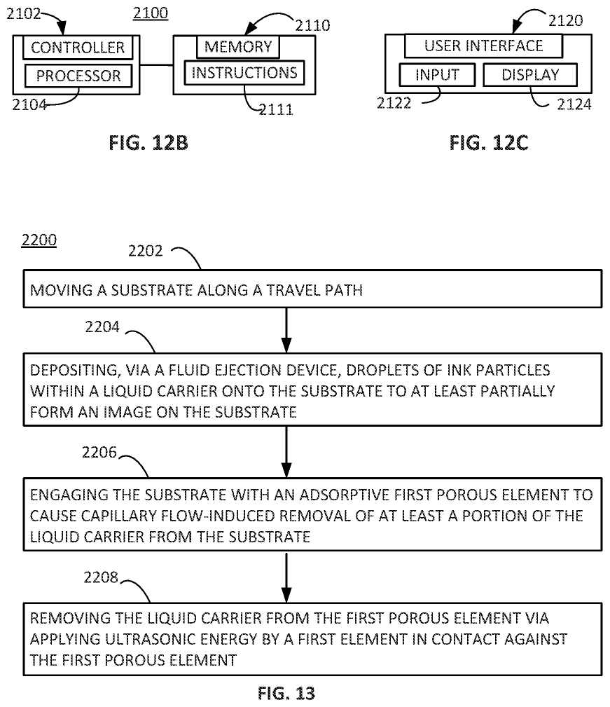

In some examples, application of the ultrasonic energy may be controlled and/or tracked in association with an ultrasonic parameter (e.g. 1286) of an image formation engine (e.g. 1250), such as later described in association with at least FIG. 12A and/or in association with control portion 2100 in FIG. 12B.

It will be understood that in some examples the first porous element 150 comprises a structure and/or materials adapted to cause capillary flow of liquids through the first porous element 150. In some such examples, the structure and/or the materials forming the first porous element 150 may induce or cause adsorption of liquids, such as a liquid carrier 132. Accordingly, in some instances, the first porous element 150 may sometimes be referred to as an adsorptive porous element. At least some of these details are described further below in association with at least FIGS. 4B-4D.

FIG. 4B is a diagram including a side view schematically representing an example first porous element 470 including a plurality of channels 473. In some examples, the first porous element 470 comprises one example implementation of the first porous element 150, 250, 350 as previously described in association with FIGS. 1-4A and/or of later described example first porous elements and/or second porous elements. In general terms, the first porous element 470 may comprise a wide variety of materials and/or structures to induce a liquid to flow through the first porous element 470, whether via capillary flow and/or via other flow mechanisms, as represented via liquid flow arrows L. In at least some examples, the first porous element 470 may comprise and/or be modeled as a plurality of channels, such as but not limited to, the plurality of side-by-side channels 473 shown in FIG. 4B. Each channel 473 is defined between and by the side walls 475 of spaced apart, side-by-side elongate elements 472.

FIG. 4C is a diagram including a side view schematically representing one example first porous element 481, which comprises one example implementation of the first porous element 150 (e.g. FIG. 4A). In some examples, the example first porous element 481 may comprise an example implementation of one of the first porous elements as previously described in association with at least FIGS. 1-4A for use in removing liquid in a first liquid removal zone Z1.

As shown in FIG. 4C, in some examples, first porous element 481 may comprise multiple layers, such as but not limited to layers 483, 485, 487. In some examples, the first layer 483 comprises an adhesion prevention layer 483, which may comprise a hydrophobic material, and which may have a thickness (T7) on the order of 10 microns. In some examples, the second layer 485 may comprise a porous media layer for liquid adsorption, and which may have a thickness (T8) on the order of 100 to 1000 microns. In some examples, the third layer 487 may comprise a support layer, and which may have a thickness (T9), which may in some examples be greater than the thickness T8 of second layer 485. In some examples, the third layer 487 acts as a support layer and may comprise a flexible woven material, which may comprise a metal or a polymer. In some examples, the third layer 487 may comprise pores to permit liquid to flow through layer 487 after it passes through layers 483, 485 during liquid removal from the substrate. In some such examples, the pores may have an average diameter of on the order of 100 microns.

In some examples, the first layer 483 is to engage the substrate 105, 405 while the second layer 485 sandwiched between layers 483, 487 acts to induce capillary flow.

In some examples, the third layer 487 (e.g. support layer) may correspond to an inner portion 468 of first porous element 450 in FIG. 4A while the first layer 483 corresponds to an outer portion 469 of first porous element 450 in FIG. 4A. In some examples, such as FIGS. 7A-7E, the support layer 487 may be oriented toward (e.g. face) an interior of a drum (e.g. 718) while the first layer 483 may define an outermost external surface of the drum 718. In some such examples, the third layer 487 (e.g. support layer) may comprise separate sections, as formed via the parallel, separate lines 488 as shown in FIG. 4C, extending generally perpendicular to a length (L1) of the first porous element 481. In one aspect, upon the application of ultrasonic energy from a first end portion (e.g. 462) of an ultrasonic element 460 as represented by directional arrow U, the orientation and generally parallel, side-by-side arrangement of the sections (between lines 488) of the third layer 487 may reduce the transmission of ultrasound energy in the direction AZ while promoting the transmission of ultrasound energy in the direction parallel to arrow U. This arrangement enhances the effectiveness and/or efficiency of the ultrasound energy driving the liquid out of the first porous element 481.

However, in some examples, as shown in FIG. 4D the third layer 487 may comprise different portions arranged in an alternating manner along the length (L1) of the first porous element 481 (in orientation AZ) with the some portions 492 having an elastic modulus different than other portions 493. In some such examples, this arrangement may inhibit transmission of ultrasound energy in the orientation (AZ) along the length of the first porous element 481.

Conversely, in some examples in which the third layer 487 is made of a single material or single composition (i.e. without alternating portions 492, 493 of differing elastic modulus) such as depicted in FIG. 4C, the ultrasound energy may naturally decay in the direction/orientation (AZ) along the length (L1) of the first porous element 481 such that transmission of ultrasonic energy (emitted via element 460) in that orientation is naturally inhibited. In this way, most of the ultrasonic energy emitted by the ultrasonic element 460 becomes utilized in driving liquid in an orientation generally corresponding to directional arrow U (transverse to orientation AZ) to exit the first porous element 481, 450, etc.

FIG. 5 is a diagram including a side view schematically representing an example image formation device 500. In some examples, the image formation device 500 comprises at least some of substantially the same features and attributes as the image formation device 100 (including liquid removal arrangement 157) in FIG. 1, with substrate 105 being implemented as a substrate 505 supported by a rotatable drum 508. In some instances, the substrate 505 may be referred to as an outer portion of rotatable drum 508. In a manner consistent with FIG. 1, the image formation device 500 comprises a fluid ejection device 110 and first porous element 550 arranged in series about an external surface of substrate 505 which rotates (as represented by arrow R). The rotating substrate 505 receives, via the fluid ejection device 110, deposited droplets 111 (of colorants 134 within a liquid carrier 132) to at least partially form an intended image on the substrate 505. After such deposition, the first porous element 550 removes at least a portion of the liquid carrier from the substrate 505. In some such examples, it will be understood that at this point in the process of forming an image on the substrate, the first porous element 550 is not acting to remove ink residue from substrate 505 in the same manner as is to be performed later by cleaner unit 543 after formation of the image on the substrate 505 has been fully completed, such as after media transfer station 560.

In some examples, the first porous element 550 of liquid removal arrangement 557 may comprise at least some of substantially the same features and attributes as the first porous element 150 (e.g. part of liquid removal arrangement 157) previously described in association with FIGS. 1-4D and/or those first porous elements (and associated liquid removal arrangements) later described in association with at least FIGS. 7A-11.

As further shown in FIG. 5, in some examples image formation device 500 may comprise a second liquid removal element 570 downstream from the first porous element 550 to further remove liquid (including but not limited to liquid carrier 132) from the substrate 505. In some examples, the second liquid removal element 570 may comprise a heated air dryer, a radiative element (e.g. ultraviolet, infrared, etc.), or other liquid drying element, each of which will not disturb the deposited colorant on the substrate 505 while removing any remaining liquid from substrate 505.

As further shown in FIG. 5, the image formation device 500 may comprise a media transfer station 560, which may comprise an impression roller or cylinder 566 which forms a nip 561 with drum 508 to cause transfer of the formed image on substrate 505 of drum 508 to print medium 546 moving along path W. It will be understood that other forms and/or types of media transfer stations may be implemented in place of transfer station 560.

As further shown in FIG. 5, in some examples the image formation device 500 may comprise a cleaner unit 543, which follows the media transfer station 560 and which precedes the fluid ejection device 110. The cleaner unit 543 is to remove any residual colorants 132 and/or components of droplets 111 from the substrate 505 prior to operation of the fluid ejection device 110. In some examples, the image formation device 500 also may omit the cleaner unit 543.

In some examples, the image formation device 500 also may comprise a primer unit, like primer unit 690 described below in association with at least FIG. 6.

FIG. 6 is a diagram including a side view schematically representing an example image formation device 600. In some examples, the image formation device 600 comprises at least some of substantially the same features and attributes as the image formation device 100 in FIG. 1-4D, except with a substrate 605 being implemented as a belt 606 in a belt arrangement 607 (instead of a drum-type arrangement) among other differences noted below. As shown in FIG. 6, the substrate-belt arrangement 607 includes an array 611 of rollers 612, 614, 616, 618, with at least one of these respective rollers comprising a drive roller and the remaining rollers supporting and guiding the substrate 605. Via these rollers, the substrate 605 (as belt 606) continuously moves in travel path T to expose the substrate 605 to at least the fluid ejection device 110 and first porous element 650, in a manner consistent with the devices as previously described in association with at least FIGS. 1A-4D.

In some such examples, the belt 606 may sometimes be referred to as an endless belt or endless loop.

In a manner consistent with at least FIGS. 1-4D, the image formation device 600 comprises a fluid ejection device 110 and first porous element 650 arranged along the travel path T through which the substrate 605 moves so that the substrate 605 may receive, via the fluid ejection device 110, deposited droplets 111 (of colorants 134 within a liquid carrier 132) to at least partially form an intended image on the substrate 605. After such deposition, first porous element 650 removes at least a portion of the liquid carrier 132 from the substrate 605. In some examples, the first porous element 650 (as part of liquid removal arrangement 657) may comprise at least some of substantially the same features and attributes as the first porous element 150 (of liquid removal arrangement 157) previously described in association with FIGS. 1A-4D and/or those first porous elements (and associated liquid removal arrangements) later described in association with at least FIGS. 7A-11.

As further shown in FIG. 6, in some examples image formation device 600 may comprise a second liquid removal element 570 downstream from the first porous element 650 to further remove liquid (including but not limited to liquid carrier 132) from the substrate 605. As further shown in FIG. 6, in some examples the image formation device 600 may comprise a media transfer station 660, which may comprise an impression roller or cylinder 667 which forms a nip 661 with roller 618 to cause transfer of the formed image from substrate 605 at roller 618 onto print medium 646 moving along path W. As further shown in FIG. 6, in some examples the image formation device 600 may comprise a cleaner unit 643 which follows the media transfer arrangement 660 and which precedes at least the fluid ejection device 110. The cleaner unit 643 is to remove any residual colorants 132 and/or components of droplets 111 from the substrate 605 prior to operation of the fluid ejection device 110.

As further shown in FIG. 6, in some examples the image formation device 600 comprises a primer unit 690 which precedes (i.e. is upstream from) the fluid ejection device 110 and which may deposit a primer layer or layer of binder material onto the substrate 605 and onto which the image may be formed, such as via operation of fluid ejection device 110, first porous element 650, second liquid removal element 570, etc. In some examples, this primer layer or binder layer may be transferred with the formed image onto the print medium 646.

In some examples, such a primer unit 690 may be implemented in the image formation device 500 of FIG. 5 with the primer unit 690 being located between the cleaner unit 543 and the fluid ejection device 110.

FIG. 7A is a diagram including a side view schematically representing an example image formation device 700. In some examples, the image formation device 700 comprises at least some of substantially the same features and attributes as the example image formation devices as previously described in association with at least FIG. 5, except at least further defining the first porous element 550 (of liquid removal arrangement 557) as a liquid removal arrangement 757, as shown in FIG. 7A. Accordingly, as shown in FIG. 7A, the liquid removal arrangement 757 comprises a first porous element 750 arranged as an outer portion 753 of a rotatable drum 718.

As further shown in FIG. 7A, drum 508 rotates in a first direction (clockwise in this example as represented by arrow R1), while the drum 718 of the liquid removal arrangement 575 rotates in a second direction (counterclockwise as represented by arrow R2). Drum 718 is positioned to be in pressing contact against the substrate 505 at a nip 561 which defines a contact zone or first liquid removal zone Z1, as shown via dashed lines in FIG. 7A. Via the first porous element 750 (as outer portion 753 of drum 718) and the rotating action of the respective drums 508, 718, the liquid carrier 132 is removed from substrate 505 via capillary action in the first liquid removal zone Z1 in a manner consistent with that described in at least FIGS. 1-7E to remove liquid (e.g. liquid carrier 132) from the substrate 505.

In some such examples, the drum 718 rotates at a speed which is substantially the same as the speed at which substrate 505 moves via rotation of supporting drum 508. In one aspect, this arrangement may minimize or eliminate shear forces, which might otherwise be present if the drum 718 and drum 508 were moving at substantially different speeds.

As further shown in FIG. 7A, the liquid removal arrangement 757 comprises an ultrasonic element 460 (FIG. 4A) positioned within an interior of drum 718 with a first end portion 462 of the ultrasonic element 460 in slidable contact against an inner surface 751A of the outer portion 753 of the rotatable drum 718, which moves past the ultrasonic element 460 as the drum 718 rotates. In a manner similar to that described in association with at least FIG. 4A, the ultrasonic element 460 emits ultrasonic waves to drive the liquid (earlier removed from the substrate 505 in zone Z1) out of the first porous element 750 and into the collection reservoir 466 (as represented via directional arrow U). In this arrangement, the ultrasonic element 460 is positioned external to the first porous element 750 and on an opposite side of the first porous element 750 from the ultrasonic element 460. Via this particular configuration in which the ultrasonic element 460 is aligned vertically above the collection reservoir 466, gravity may act to guide the expelled liquid directly into the reservoir 466. The collected liquid may be recycled, reused, and/or discarded.

Via this arrangement, in the first contact zone Z1, the first porous element 750 acts to remove excess liquid carrier (132 in FIG. 1) from the substrate 505 of the rotating drum 508 and at a later time in second contact zone Z2, the ultrasonic element 460 drives the liquid out of the first porous element 750 into collection reservoir 466.

As further shown in FIG. 7A, and in a manner consistent with the image formation device 500 (FIG. 5), after the first porous element 750 removes the excess liquid carrier from the substrate 505, a second liquid removal element 570 may act to further remove any remaining liquid from the substrate 5050 while leaving the colorant (in its intended pattern as an image) on the substrate 505.

Further downstream from the second liquid removal element 570, the image on substrate 505 is transferred onto an image formation medium such as via a transfer station 777, which is schematically represented as a block, but which may comprise at least some of substantially the same features as transfer station 560 in FIG. 5 or may comprise another type of transfer station such one in which the image formation medium comprises a continuous web rather than a sheet.

In some examples, the substrate 505 is hard (e.g. not compressible) and the drum 508 supporting the substrate comprises a relative soft, compressible material. However, in some examples, the substrate 505 comprises a relatively soft, compressible outer portion while the drum 508 (on which substrate 505 is mounted) comprises a hard (e.g. not compressible) structure and/or material. In some examples, the substrate 505 may comprise a thickness on the order of 1 millimeter while the first porous element 750 (as outer portion 753) may comprise a thickness of about 100 micro-meters.

FIG. 7B is a diagram including a side view schematically representing an example liquid removal arrangement 857, which comprises at least some of substantially the same features and attributes as liquid removal arrangement 757 (FIG. 7A), except with the ultrasonic element 460 having a non-vertical orientation, such as but not limited to, a horizontal orientation relative to a collection reservoir 466. Moreover, the liquid removal arrangement 857 comprises a vacuum source VS to apply a vacuum pressure on the expelled liquid to pull the liquid into the reservoir 466 despite the non-vertical orientation of the ultrasonic element 460. It will be understood that, in some such examples, the reservoir 466 may be configured to enable application of the vacuum while still holding the collected liquid and/or directing the liquid for recycling, reuse, and/or disposal.

In the particular configurations shown in FIGS. 7A and 7B, the ultrasonic element 460 is located within an interior of the rotatable drum 718. However, in some examples, such as the liquid removal arrangement 957 in FIG. 7C, the ultrasonic element 460 may be located externally of the rotatable drum 718 and the collection reservoir 466 may located on an interior of the drum 718. Moreover, in a manner similar to that shown in FIG. 7B, a vacuum source VS may be provided in association with the collection reservoir 466 to enhance collection of the liquid (expelled from the first porous element 750) despite a non-vertical orientation of the ultrasonic element 460.

However, in some examples in which the ultrasonic element 460 is located external to the drum 718, the ultrasonic element 460 of a liquid removal arrangement 1157 may be positioned in a generally vertical orientation as shown in FIG. 7E to enable gravity to guide the expelled liquid (caused via ultrasonic energy) into the collection reservoir 466.

As shown in FIG. 7D, in some examples a liquid removal arrangement 1057 may comprise an array 1063 of ultrasonic elements 1060 (each like element 460) located within an interior of the drum 718 and each having a first end portion 1062 in slidable contact with the inner surface (e.g. 751A in FIG. 7A) of the first porous element 750. In one aspect, by providing several ultrasonic elements 1060 in a side-by-side relationship, the array 1063 may increase the liquid removal capacity of a liquid removal arrangement and/or make such liquid removal more uniform.

FIG. 8A is a diagram including a side view schematically representing an example image formation device 1200 including a liquid removal arrangement 1259, which includes a first porous element 1250 for removing from a substrate 705. In some examples, the example image formation device 1200 comprises at least some of substantially the same features and attributes as the image formation devices, as previously described in association with at least FIGS. 1-7E, except with the liquid removal arrangement 1259 in a belt-type configuration. As shown in FIG. 8A, in some examples, the substrate 505 may take the form of an outer portion of a drum 508 as also shown in FIG. 5 and FIG. 8A. However, it will be understood that in some examples the drum-type substrate 505 may be replaced by a belt-type substrate like belt 606 as shown in FIG. 6 for the example image formation device 600.

As further shown in FIG. 8A, the first porous element 1250 forms part of the liquid removal arrangement 1259 in which the first porous element 1250 comprises a belt 1251 supported by, and rotating in an endless loop, about a plurality of rollers, such as rollers 1262, 1263, 1264 with at least one of these rollers comprising a drive roller. Each of the rollers 1262, 1263, 1264 (supporting belt 1251) rotate in a first direction (counterclockwise in this example as represented by arrow R2), while the drum 508 rotates in a second direction (clockwise as represented by arrow R1).

Roller 1262 is positioned to be in pressing contact against the substrate 505 to define a nip 1261 which also defines a first contact zone Z1 (e.g. first liquid removal zone), as shown via dashed lines in FIG. 8A. Via the first porous element 1250, liquid is removed from substrate 505 in the first contact zone Z1 in a manner consistent with that described in at least FIGS. 1-7E to remove liquid (e.g. liquid carrier 132) from the substrate 505.

Because the first porous element 750 in the form of a belt 1251 rotates in a loop (as represented by directional arrow E), different portions of belt 1251 will engage the substrate 505 as the belt 1251 rotates. Similarly, at the same time that the belt 1251 is rotating (directional arrow E) in a loop, the substrate 505 is rotating per directional arrow R1. As shown in FIG. 8A, roller 1262 rotates (arrow R2) in a direction complementary with the rotation of substrate 505. In some such examples, the belt 1251 moves (rotates in the endless loop) at a speed which is substantially the same as the speed at which substrate 505 rotates as part of drum 508. In one aspect, this arrangement may minimize or eliminate shear forces, which might otherwise be present if the belt 1251 and substrate 505 were moving at substantially different speeds.

As further shown in FIG. 8A, the liquid removal arrangement 1259 comprises an ultrasonic element 460 including a first end portion 462 in slidable contact against belt 1251 and which drives liquid out of the first porous element (e.g. belt 1251) and into a collection reservoir 466, in a manner similar to that described in association with at least FIGS. 4A, 7A-7E. As shown in FIG. 8A, the ultrasonic element 460 is located along a portion of belt 1251 which is downstream from the first contact zone Z1 and located intermediate between rollers 1262, 1264, and which may define a second contact zone Z2 (e.g. second liquid removal zone) as shown in dashed lines.

In this example configuration, the ultrasonic element 460 is located within an interior of the loop defined by belt 1251 and the reservoir 466 is positioned external to the loop defined by belt 1251. However, it will be understood that any one of the configurations (or variations thereof) of the ultrasonic element 460 and reservoir 466 as shown in FIGS. 7A-7E (regarding their respective internal or external positions) may be implemented in the examples of FIGS. 8A-8B.

FIG. 8B is a diagram including a side view schematically representing an example liquid removal arrangement 1359, which comprises at least some of substantially the same features and attributes as liquid removal arrangement 1259 (FIG. 8A), except comprising an ultrasonic element 1360 in the form of a wheel or associated with a wheel instead of being in the shape of a horn or similar configuration as shown in FIG. 8A. As shown in FIG. 8B, the ultrasonic element 1360 may be positioned in a manner similar to element 460 in FIG. 8A, while being in rolling contact with the belt 1251 (as represented by directional arrow R2). As in the prior examples, the drum-type ultrasonic element 1363 may drive liquid out of first porous element 1250 for collection in reservoir 466.

It will be further understood that the liquid taken into a first porous element via ultrasonic energy (from elements 460, 1360, etc.) is to be removed in a second contact zone (Z2) so that a given portion of the first porous element (e.g. belt 1251) may be “dried” enough so that upon its next pass through the nip 1261, the given portion of the first porous element (e.g. belt 1251) will be ready and able to remove liquid from the substrate 505 in the first contact zone Z1.

FIG. 9A is a diagram 1400 schematically representing an example image formation device 1400 including an example liquid removal arrangement 1459. In some examples, the image formation device 1400 comprises at least some of substantially the same features and attributes as the image formation devices as previously described in association with at least FIGS. 1-8B, with like reference numerals referring to like elements. Like the previously described examples throughout the present disclosure, in some examples the image formation device 1400 comprises a fluid ejection device 110 upstream from a first contact zone Z1, and may comprise a second liquid removal element 570 downstream from a first contact zone Z1. In some examples, a primer unit 790 may precede the fluid ejection device 110.

In some examples, the liquid removal arrangement 1459 comprises at least some of substantially the same features and attributes as the liquid removal arrangements described in association with at least FIGS. 8A-8B to remove liquid from a substrate via a first porous element (e.g. 1250, 1251) in a first contact zone Z1, and/or to remove liquid from a first porous element via an ultrasonic element (e.g. 460, 1360 in FIGS. 8A-8B) in a second contact zone Z2.

Like liquid removal arrangement 1259 in FIG. 8A, the liquid removal arrangement 1459 in FIG. 9A comprises a first porous element 1450 in the form of a belt 1451 supported by a plurality of rollers 1462, 1463, 1464 (like rollers 1262, 1263, 1264), with at least one such roller comprising a drive roller. In other respects, roller 1462 may comprise features like roller 1262 in FIG. 8A.

In the example implementation in FIG. 9A, the ultrasonic element 460 (at least partially defining the second contact zone Z2) is located externally of the first porous element 1450 (as belt 1451) in a manner substantially similar to that described in association with at least FIG. 7E, 7C, and in which the collection reservoir 466 is located within an interior of the first porous element 1450 and an opposite side of the first porous element 1450 from the ultrasonic element 460.

FIG. 9A also illustrates that in some examples, the substrate 1405 may comprise a media, such as a final print medium, on which the formed image will reside. As such, in this example shown in FIG. 9A, the substrate 1405 is not directly supported by a roller or drum at the point (e.g. contact zone Z1) at which the first porous element 1450 (supported by roller 1462) engages the substrate 1405. Rather, the substrate 1405 is supported via at least rollers 1406A, 1406B, which may define media supply rollers and media take-up rollers in some examples. However, in some examples, the rollers 1406A, 1406B may comprise just some of a plurality of rollers supporting the substrate 1405, driving movement of substrate 1405, etc.

Via such example arrangements, the liquid removal arrangement 1459 is positioned and configured to employ a first porous element 1450 to remove a liquid carrier (e.g. 132 in FIG. 1) from the substrate 1405, while leaving the deposited colorants in their targeted locations on the substrate 1405, and then use an ultrasonic element 460 to remove the liquid from the first porous element 1450.

FIG. 9B is a diagram schematically representing an example image formation device 1500 comprising at least some of substantially the same features and attributes as image formation device 1400 in FIG. 9A, except for comprising a liquid removal arrangement 1557 in which the first porous element 1550 is arranged in a drum-type configuration like that of at least FIG. 7E (and FIGS. 7A-7D) instead of a belt configuration as in FIG. 9A.

Accordingly, in some examples, the liquid removal arrangement 1557 comprises at least some of substantially the same features and attributes as the liquid removal arrangements described in association with at least FIGS. 7A-7E to remove liquid from a substrate via a first porous element (e.g. 750) in a first contact zone Z1, and to remove liquid from a first porous element via an ultrasonic element (e.g. 460 in FIGS. 7A-7E) in a second contact zone Z2.

Via such example arrangements, the liquid removal arrangement 1557 is positioned and configured to employ a first porous element 750 to remove a liquid carrier (e.g. 132 in FIG. 1) from the substrate 1405, while leaving the deposited colorants in their targeted locations on the substrate 1405, and then use an ultrasonic element 460 to remove the liquid from the first porous element 750.

FIG. 10 is a diagram schematically representing an example image formation device 1700. In some examples, the image formation device 1700 comprises an example image formation device comprising at least some of substantially the same features and attributes as, and/or an example implementation of, the liquid removal arrangement 157 (FIG. 1), 250 (FIG. 2), 350 (FIG. 3), 450/470/481 (FIGS. 4A-4D), 557 (FIG. 5), 657 (FIG. 6), 757, 857, 957, 1057, 1157 (FIGS. 7A-7E), 1259, 1359 (FIGS. 8A-8B), 1459, 1557 (FIGS. 9A-9B), and/or 1857 (FIG. 11).

The image formation device 1700 comprises at least some of substantially the same features and attributes as the image formation devices described in association with at least FIGS. 1-4D, 5, and 6. Moreover, as shown in FIG. 10, in some examples, downstream from the fluid ejection device 110, the image formation device 1700 may comprise a charge emitter 1140 to emit charges onto deposited droplets 111 (of colorants 134 within a liquid carrier 132) to cause electrostatic migration of the colorants 134 through the liquid carrier 132 toward the substrate 105 as shown in portion 1722 of FIG. 10, and to cause electrostatic fixation of the colorants 134 against the substrate 105, as shown in portion 1724 of FIG. 10. In some examples, the liquid carrier 132 may comprise a non-aqueous fluid, which in some examples may comprise a low viscosity, dielectric oil, such as an isoparaffinic fluid. Some versions of such dielectric oil may be sold under the trade name Isopar®. Among other attributes, the non-aqueous liquid carrier may be more easily removed from the substrate 105 (than an aqueous liquid carrier), at least to the extent that the substrate 105 may comprise some aqueous absorptive properties. In some examples, the non-aqueous fluid may comprise charge directors and/or dispersants to implement low field conductivity, which may facilitate removal of the liquid carrier 132 in its non-aqueous form from the substrate 105.

As further shown in dashed box B of portion 1722 of FIG. 10, the deposited charges 1143 become attached to the deposited colorants 134, which then migrate to substrate 105 due to the electrostatic forces of the charges 1143 being attracted to the grounded substrate 105. Moreover, as shown in dashed box C in portion 1724 of FIG. 10, upon all of the deposited colorants 134 (with attached charges 1143) becoming electrostatically fixed relative to the substrate 105, the liquid carrier 132 exhibits a supernatant relationship relative to the colorants 134, which are electrostatically fixed against the substrate 105. With the liquid carrier 132 in this arrangement, the liquid carrier 132 can be readily removed from the substrate 105 without disturbing (or without substantially disturbing) the electrostatically fixed colorants 134 in their desired, targeted position on the substrate 105 by which an image is at least partially formed. With this in mind, at 1726 in FIG. 10, the liquid removal arrangement 1747 acts to remove the liquid carrier 132 from the substrate 105 in a manner consistent with the previously described examples of a liquid removal arrangement, such as but not limited to liquid removal arrangements 157 (FIG. 1), 250 (FIG. 2), 350 (FIG. 3), 450/470/481 (FIGS. 4A-4D), 557 (FIG. 5), 657 (FIG. 6), 757, 857, 957, 1057, 1157 (FIGS. 7A-7E), 1259, 1359 (FIGS. 8A-8B), 1459, 1557 (FIGS. 9A-9B), and/or 1857 (FIG. 11).

With further reference to FIG. 10, the charge emitter 1140 may comprise a corona, plasma element, or other charge generating element to generate a flow of charges. The charge emitter 1140 may sometimes be referred to as a charge source, charge generation device, and the like. The generated charges may be negative or positive as desired. In some examples, the charge emitter 1140 comprises an ion head to produce a flow of ions as the charges. It will be understood that the term “charges” and the term “ions” may be used interchangeably to the extent that the respective “charges” or “ions” embody a negative charge or positive charge (as determined by emitter 1140).

In the particular instance shown in FIG. 10, the emitted charges 1143 can become attached to the colorants 134 to cause all of the charged colorants to have a particular polarity, which will be attracted to ground. In some such examples, all or substantially all of the charged colorants 134 will have a negative charge or alternatively all or substantially all of the charged colorants 134 will have a positive charge.

FIG. 11 is a diagram including a side view schematically representing an example image formation device 1800, which comprises at least one example implementation of the image formation device 1700 of FIG. 10. In some examples, the image formation device 1800 comprises at least some of substantially the same features and attributes as image formation device 500 in FIG. 5, while further comprising a charge emitter 1140 located along the travel path T of substrate 505 (on rotatable drum 508) between the fluid ejection device 110 and the first porous element 1850 of liquid removal arrangement 1857. In a manner similar to that represented in FIG. 10, the charge emitter 1140 emits charges (e.g. 1143 in FIG. 10) to cause electrostatic migration of the colorants 134 through the liquid carrier 132, and electrostatic fixation of, colorants 134 relative to substrate 505 in manner described in association with FIG. 10. As in the example of FIG. 10, the liquid carrier 132 may be a non-aqueous fluid.

FIG. 12A is a block diagram schematically representing an example image formation engine 1950. In some examples, the image formation engine 1950 may form part of a control portion 2100, as later described in association with at least FIG. 12B, such as but not limited to comprising at least part of the instructions 2111. In some examples, the image formation engine 1950 may be used to implement at least some of the various example devices and/or example methods of the present disclosure as previously described in association with FIGS. 1-11 and/or as later described in association with FIGS. 12B-13. In some examples, the image formation engine 1950 (FIG. 12A) and/or control portion 2100 (FIG. 12B) may form part of, and/or be in communication with, an image formation device.

In general terms, the image formation engine 1950 is to control at least some aspects of operation of the image formation devices and/or methods as described in association with at least FIGS. 1-11 and 12B-13.

As shown in FIG. 12A, the image formation engine 1950 may comprise a fluid ejection engine 1952, a charge emitter engine 1954, and/or a liquid removal engine 1980.

In some examples, the fluid ejection engine 1952 controls operation of the fluid ejection device 110 (e.g. at least FIG. 1) to deposit droplets of colorants 134 within a liquid carrier 132 onto a substrate 105 (e.g. at least FIG. 1) as described throughout the examples of the present disclosure.

In some examples, the charge emitter engine 1954 is to control operation of a charge emitter (e.g. 1140 in FIGS. 10, 11) to emit airborne electrical charges to induce electrostatic migration of colorants 134 toward the substrate 105 and electrostatic fixation of the migrated colorants 134 at their target locations in a pattern at least partially forming an image, such as described in association with FIGS. 10-11 and/or various examples throughout the present disclosure.

In some examples, in general terms the liquid removal engine 1980 controls operation of at least a liquid removal arrangement to remove the liquid carrier (e.g. 132 in FIG. 1) from a substrate (e.g. 105 in FIG. 1) and/or from a first porous element via an ultrasonic element. Such control may comprise control of operation of at least the various elements, portions, aspects of the liquid removal throughout the examples of the present disclosure, such as but not limited to the examples of 157 (FIG. 1), 250 (FIG. 2), 350 (FIG. 3), 450/470/481 (FIGS. 4A-4D), 557 (FIG. 5), 657 (FIG. 6), 757, 857, 957, 1057, 1157 (FIGS. 7A-7E), 1259, 1359 (FIGS. 8A-8B), 1459, 1557 (FIGS. 9A-9B), 1747 (FIG. 10), and/or 1857 (FIG. 11).

In some examples, the liquid removal engine 1980 comprises a position parameter 1981 to control a position of a first porous element (as a drum or belt), such as via controlling a position of a roller(s) and/or drum via which the first porous element is implemented. Similarly, in some examples the position parameter 1981 is to control a position of an ultrasonic element relative to a position of a roller(s) and/or drum via which the first porous element is implemented.

In some examples, the liquid removal engine 1980 may comprise a speed parameter 1982 by which a speed of a belt or rotatable drum of a substrate (or of a first porous element) is controlled (and/or tracked) via operation of the support and/or drive rollers of one of the various example belt arrangements described in association with at least FIGS. 1-9B.

In some examples, the liquid removal engine 1980 may comprise an ultrasonic parameter 1986 to control (and/or track) the ultrasonic energy applied to drive liquid out of a first porous element. Moreover, in some examples, the ultrasonic parameter 1981 may control oscillations (e.g. frequency, amplitude, etc.) of the ultrasonic waves (e.g. energy) emitted by an ultrasonic element (in contact with a first porous element) in order to control a speed, volume, etc. of liquid being driven out of the first porous element. In some such examples, this control may control a degree of cavitation of the liquid within the first porous element to control driving the liquid out of the first porous element.

It will be understood that, in at least some examples, the image formation engine 1950 is not strictly limited to the particular grouping of parameters, engines, functions, etc. as represented in FIG. 19A, such that the various parameters, engines, functions, etc. may operate according to different groupings than shown in FIG. 12A.

FIG. 12B is a block diagram schematically representing an example control portion 2100. In some examples, control portion 2100 provides one example implementation of a control portion forming a part of, implementing, and/or generally managing the example image formation devices, as well as the particular portions, fluid ejection devices, charge emitters, porous elements, ultrasonic elements, liquid removal elements, elements, devices, user interface, instructions, engines, parameters, functions, and/or methods, as described throughout examples of the present disclosure in association with FIGS. 1-12A and 12C-13.

In some examples, control portion 2100 includes a controller 2102 and a memory 2110. In general terms, controller 2102 of control portion 2100 comprises at least one processor 2104 and associated memories. The controller 2102 is electrically couplable to, and in communication with, memory 2110 to generate control signals to direct operation of at least some the image formation devices, various portions and elements of the image formation devices, such as fluid ejection devices, charge emitters, porous elements, ultrasonic elements, liquid removal elements, user interfaces, instructions, engines, functions, and/or methods, as described throughout examples of the present disclosure. In some examples, these generated control signals include, but are not limited to, employing instructions 2111 stored in memory 2110 to at least direct and manage depositing droplets of colorants and liquid carrier to form an image on a media, jetting droplets, directing charges onto colorants, removing liquids (e.g. via porous elements, ultrasonic elements, etc.), etc. as described throughout the examples of the present disclosure in association with FIGS. 1-12A and 12C-13. In some instances, the controller 2102 or control portion 2100 may sometimes be referred to as being programmed to perform the above-identified actions, functions, etc. In some examples, at least some of the stored instructions 2111 are implemented as a, or may be referred to as, a print engine, an image formation engine, and the like, such as but not limited to the image formation engine 1950 in FIG. 12A.

In response to or based upon commands received via a user interface (e.g. user interface 2120 in FIG. 12C) and/or via machine readable instructions, controller 2102 generates control signals as described above in accordance with at least some of the examples of the present disclosure. In some examples, controller 2102 is embodied in a general purpose computing device while in some examples, controller 2102 is incorporated into or associated with at least some of the image formation devices, portions or elements along the travel path, fluid ejection devices, charge emitters, porous elements, ultrasonic elements, liquid removal elements, user interfaces, instructions, engines, functions, and/or methods, etc. as described throughout examples of the present disclosure.

For purposes of this application, in reference to the controller 2102, the term “processor” shall mean a presently developed or future developed processor (or processing resources) that executes machine readable instructions contained in a memory or that includes circuitry to perform computations. In some examples, execution of the machine readable instructions, such as those provided via memory 2110 of control portion 2100 cause the processor to perform the above-identified actions, such as operating controller 2102 to implement the formation of an image as generally described in (or consistent with) at least some examples of the present disclosure. The machine readable instructions may be loaded in a random access memory (RAM) for execution by the processor from their stored location in a read only memory (ROM), a mass storage device, or some other persistent storage (e.g., non-transitory tangible medium or non-volatile tangible medium), as represented by memory 2110. The machine readable instructions may include a sequence of instructions, a processor-executable machine learning model, or the like. In some examples, memory 2110 comprises a computer readable tangible medium providing non-volatile storage of the machine readable instructions executable by a process of controller 2102. In some examples, the computer readable tangible medium may sometimes be referred to as, and/or comprise at least a portion of, a computer program product. In other examples, hard wired circuitry may be used in place of or in combination with machine readable instructions to implement the functions described. For example, controller 2102 may be embodied as part of at least one application-specific integrated circuit (ASIC), at least one field-programmable gate array (FPGA), and/or the like. In at least some examples, the controller 2102 is not limited to any specific combination of hardware circuitry and machine readable instructions, nor limited to any particular source for the machine readable instructions executed by the controller 1402.

In some examples, control portion 2100 may be entirely implemented within or by a stand-alone device.

In some examples, the control portion 2100 may be partially implemented in one of the image formation devices and partially implemented in a computing resource separate from, and independent of, the image formation devices but in communication with the image formation devices. For instance, in some examples control portion 2100 may be implemented via a server accessible via the cloud and/or other network pathways. In some examples, the control portion 2100 may be distributed or apportioned among multiple devices or resources such as among a server, an image formation device, and/or a user interface.

In some examples, control portion 2100 includes, and/or is in communication with, a user interface 2120 as shown in FIG. 19C. In some examples, user interface 2120 comprises a user interface or other display that provides for the simultaneous display, activation, and/or operation of at least some of the image formation devices, portions thereof, elements, user interfaces, instructions, engines, functions, and/or methods, etc. as described in association with FIGS. 1-19B and 20. In some examples, at least some portions or aspects of the user interface 2120 are provided via a graphical user interface (GUI), and may comprise a display 2124 and input 2122.

FIG. 13 is a flow diagram schematically representing an example method. In some examples, method 2200 may be performed via at least some of the same or substantially the same image formation devices, portions, fluid ejection devices, charge emitters, porous elements, ultrasonic elements, liquid removal elements, elements, control portion, user interface, etc. as previously described in association with FIGS. 1-12C. In some examples, method 2200 may be performed via at least some of the same or substantially the same image formation devices, portions, fluid ejection devices, charge emitters, porous elements, ultrasonic elements, liquid removal elements, control portion, user interface, etc. other than those previously described in association with FIGS. 1-12C.

As shown at 2202 in FIG. 13, in some examples method 2200 may comprise moving a substrate along a travel path. As shown at 2204 in FIG. 13, method 2200 may comprise depositing, via a fluid ejection device, droplets of colorants within a liquid carrier onto the substrate to at least partially form an image on the substrate.

As shown at 2206 in FIG. 20, method 2200 may comprise engaging the substrate with an adsorptive first porous element to cause capillary flow-induced removal of at least a portion of the liquid carrier from the substrate. As further shown at 2208 in FIG. 13, method 220 may comprise removing the liquid carrier from the first porous element via applying ultrasonic energy by a first element in contact against the first porous element.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein.

1. An image formation device comprising:
a support to support movement of a substrate along a travel path;
a fluid ejection device along the travel path to deposit droplets of colorants within a liquid carrier onto the substrate to at least partially form an image on the substrate; and
an adsorptive first porous element located downstream from the fluid ejection device to be in contact against the substrate to remove, via capillary flow, at least a portion of the liquid carrier from the substrate; and
an ultrasonic element in contact against the first porous element, at a location separated from a location at which the first porous element engages the substrate, to drive the removed liquid carrier out of the first porous element.

2. The image formation device of claim 1, wherein the first porous element comprises a first belt supported by a plurality of rollers, and the ultrasonic element is positioned intermediate between an adjacent pair of rollers, the device comprising a reservoir positioned on opposite side of the ultrasonic element.

3. The image formation device of claim 2, wherein the ultrasonic element comprises a drum shaped member in rolling contact with the first porous element.

4. The image formation device of claim 1, wherein the first porous element comprises an outer portion of a rotatable drum.

5. The image formation device of claim 4, wherein the ultrasonic element is positioned on a first side of the outer portion of the rotatable drum and the device comprises a liquid reservoir on an opposite second side of the outer portion of the rotatable drum across from the ultrasonic element to collect the liquid carrier.

6. The image formation device of claim 5, comprising:
a vacuum element, positioned on an opposite side of first porous element relative to the ultrasonic element, to apply vacuum pressure to assist removal of the liquid carrier from the first porous element into the liquid reservoir.

7. The image formation device of claim 5, wherein the ultrasonic element comprises an array of first ultrasonic elements arranged in a side-by-side relationship with the first portion of each respective first ultrasonic element in contact against the inner portion of the rotatable drum.

8. The image formation device of claim 1, wherein the substrate comprises at least one of:
an outer portion of a rotatable drum in rolling contact with the first porous element; and
a second belt supported by an array of spaced apart rollers, wherein one of the respective rollers supports the second belt directly across from the point at which the first porous element contacts the substrate.

9. The image formation device of claim 1, wherein the fluid ejection device is to deposit the colorants within the liquid carrier as an aqueous liquid carrier.

10. The image formation device of claim 1, comprising:
a first charge emitter downstream along the travel path from the fluid ejection device, and upstream from the location at which the first porous element contacts the substrate, to emit airborne charges to cause electrostatic fixation of at least the deposited colorants relative to the substrate,
wherein the liquid carrier comprises a non-aqueous liquid carrier.

11. An image formation device comprising:
a support to support movement of a substrate along a travel path;
a fluid ejection device along the travel path to deposit droplets of colorants within a liquid carrier onto the substrate to at least partially form an image on the substrate; and
an adsorptive first porous element downstream along the travel path from the fluid ejection device;
a first contact zone in which the first porous element is to be in movable contact against the substrate to induce capillary flow of the liquid carrier through the first porous element to remove at least a portion of the liquid carrier from the substrate; and
an ultrasonic element in contact against the first porous element, at a location separate from the first contact zone, to drive the removed liquid carrier from the first porous element.

12. The image formation device of claim 11, wherein the first porous element comprises at least one of:
an outer portion of a rotatable drum in rolling contact with the substrate; or
a second belt supported by an array of spaced apart rollers, and the contact zone being defined at a respective one of the rollers.

13. A method comprising:
moving a substrate along a travel path;
depositing, via a fluid ejection device, droplets of colorants within a liquid carrier onto the substrate to at least partially form an image on the substrate;
engaging the substrate with an adsorptive first porous element to cause capillary flow-induced removal of at least a portion of the liquid carrier from the substrate; and
removing the liquid carrier from the first porous element via applying ultrasonic energy by a first element in contact against the first porous element.

14. The method of claim 13, comprising at least one of:
arranging the first porous element as an outer portion of a rotatable drum in rolling contact with the substrate; or
arranging the first porous element as a second belt, which is supported by an array of spaced apart rollers, and supporting engagement of the second belt against the substrate via a respective one of the rollers.

15. The image formation device of claim 1, comprising:
applying the ultrasonic energy on a first side of the first porous element and collecting the liquid carrier on an opposite second side of the porous element.
